(19) United States
(12) Patent Application Publication
(10) Pub. No.: US 2025/0049073 A1
(43) Pub. Date: Feb. 13, 2025

(54) NUTRITIONAL COMPOSITIONS FROM PLANT-BASED PROTEINS AND METHODS FOR MAKING THE SAME

(71) Applicant: Axiom Foods, Inc., Los Angeles, CA (US)

(72) Inventors: David J. Janow, Los Angeles, CA (US); Richard J. Ray, Sacramento, CA (US)

(21) Appl. No.: 18/389,624

(22) Filed: Dec. 19, 2023

Related U.S. Application Data
(60) Provisional application No. 63/518,999, filed on Aug. 11, 2023.

(51) Int. Cl. A23J 3/14

(52) U.S. Cl. CPC A23J 3/14

(57) ABSTRACT

Disclosed herein are plant-based protein compositions with improved palatability and digestibility, and methods for preparing the same. In particular, the methods disclosed herein improve the smell and taste of plant-based proteins such as pea protein.

### FIELD

Disclosed herein are methods for preparing protein composition from plant-based sources that have improved taste, smell, and digestibility.

### BACKGROUND

### Description of the Related Art

Plant-based protein powders can be a convenient way to add protein to a diet or supplement athletes with increased protein needs. Plant based protein powders are often made from pea, soy, hemp, sunflower, pumpkin, rice, or other plant sources. Such proteins can be particularly beneficial for those who wish to maintain a vegetarian or vegan diet. Plant based proteins have an amino acid score that is less than other more common proteins, but because of its unique profile, can serve as a better protein in certain applications. For instance, because of the high leucine content, such proteins can be used as a bread additive. Leucine can enhance bread aroma when cooking, etc.

Some plant proteins may have an unpleasant taste and smell. For example, pea protein outperforms many other protein sources in nutrition terms; however masking its flavor and aroma is a challenge. Some approaches to increase the palatability of pea protein include the addition of sweeteners and flavors and/or combining pea protein with other plant protein sources. Accordingly, a need exists for methods of making plant-based protein compositions having improved smell and taste.

### SUMMARY

In some embodiments, provided herein is a method of preparing a protein composition, the method comprising the steps of: (a) adding protein and a solvent to a first vessel form a first mixture; (b) adding an oxidizing agent to the first mixture to form a second mixture; and (c) isolating purified protein from the second mixture. In some embodiments, the concentration of the oxidizing agent in the second mixture is from about 0.05% to about 0.5% (w/w).

In some embodiments, the solvent comprises ethanol. In some embodiments, the solvent comprised water. In some embodiments, the solvent is water.

In some embodiments, the concentration of protein in the first mixture is from about 8% to about 20% (w/w), from about 12% to about 18% (w/w), from about 12% to about 15% (w/w). In some embodiments, the concentration of protein in the first mixture is about 15% (w/w).

In some embodiments, the first mixture may be agitated. In some such embodiments, the first mixture may be agitated until the protein is fully dispersed.

In some embodiments, the first mixture is heated to a temperature of from about 70° F. to about 200° F., from about 100° F. to about 200° F., from about 120° F. to about 180° F., or from about 140° F. to about 170° F. In some such embodiments, the first mixture is heated to a temperature of about 145° F. In other such embodiments, the first mixture is heated to a temperature of about 160° F. In other such embodiments, the first mixture is heated to a temperature of about 180° F. In other embodiments, the first mixture is maintained at room temperature.

In some embodiments, the oxidizing agent is selected from the group a peroxide or an alkali metal percarbonate. In some such embodiments, the oxidizing agent is sodium percarbonate or potassium percarbonate. In other embodiments, the oxidizing agent is a peroxide solution in water. In some such embodiments, the oxidizing agent is hydrogen peroxide solution in water. In some embodiments, the concentration of the hydrogen peroxide solution is from about 10% (v/v) to about 50% (v/v), or from about 10% (v/v) to about 50% (v/v), or from about 20% (v/v) to about 40% (v/v), or from about 25% (v/v) to about 35% (v/v). In some embodiments, the concentration of the hydrogen peroxide solution is about 35% (v/v).

In some embodiments, the concentration of hydrogen peroxide in the second mixture is from about 0.05% to about 0.5% (w/w). In some embodiments, the concentration of hydrogen peroxide in the second mixture is from about 0.05% to about 0.15% (w/w). In some embodiments, the concentration of hydrogen peroxide in the second mixture is about 0.1% (w/w).

In some embodiments, the mass ratio of solvent to protein is from about 1:1 to about 10:1. In some such embodiments, the mass ratio of solvent to protein is about 5:1.

In some embodiments, the mass ratio of protein to oxidizing agent is from about 50:1 to about 300:1, or from about 100:1 to about 200:1, or from about 150:1 to about 200:1, or from about 160:1 to about 170:1.

In some embodiments, the oxidizing agent is added to the first mixture over a period of from about 5 minutes to about 120 minutes, or over a period of from about 10 minutes to about 60 minutes, or over a period of from about 20 minutes to about 40 minutes.

In some embodiments, the second mixture is agitated for a period of from about 5 minutes to about 120 minutes, or from about 10 minutes to about 60 minutes, or from about 15 minutes to about 30 minutes.

In some embodiments, the second mixture is heated to a temperature of from about 100° F. to about 200° F., or from about 120° F. to about 180° F., or from about 140° F. to about 170° F. In some such embodiments, the second mixture is heated to a temperature of about 145° F. In other such embodiments, the second mixture is heated to a temperature of about 160° F.

In some embodiments, the method may further comprise sonicating the second mixture. In some embodiments, the second mixture is sonicated for a period of from about 1 minute to about 20 minutes, or for a period of from about 2 minutes to about 15 minutes, or for a period of from about 3 minutes to about 10 minutes, or for a period of from about 5 minutes to about 10 minutes.

In some embodiments, the second mixture may be pasteurized. In some such embodiments, the second mixture may be heated to a temperature of from about 190° F. to about 220° F. for a period of 1 minute to 10 minutes. In other such embodiments, the second mixture is further heated to a temperature of about 195° F. for a period of 1 minute to 10 minutes.

In some embodiments, the purified protein may be isolated from the second mixture. In some embodiments, the second mixture may be spray-dried.

In some embodiments, the protein is a plant-based protein. In some embodiments, the protein is a protein from barley, wheat, rice, flaxseed, coconut, buckwheat, pumpkin, hemp, pea, chia, lentil, fava, potato, corn, sunflower, soy, quinoa, amaranth, oat, sorghum, lupin, millet, teff, or a combination thereof. In some such embodiments, the protein is a pea protein.

Also provided herein are protein compositions prepared according to the methods described herein. In some embodiments, the protein composition has a PDCAAS score of from 0.96 to 1, or has a PDCAAS score of from 0.98 to 1. In some embodiments, the protein composition is a pea protein composition. In some embodiments, the composition is characterized by a PDCAAS score of greater than 0.98. In some embodiments, the protein compositions prepared according to the methods described herein have hydrogen peroxide content of from about 0.1 to about 1 ppm.

### BRIEF DESCRIPTION OF THE DRAWINGS

FIG. 1 is a flowchart depicting the plant-based purification process disclosed herein.

### DETAILED DESCRIPTION

The field of this disclosure is a food grade protein composition prepared from plant-based sources. Pea protein contains all nine essential amino acids that the human body cannot synthesize, and is a good source of branched-chain amino acids. Moreover, pea protein powder is naturally vegan and does not contain any of the top eight food allergens. However, pea protein has a distinctive and generally unpleasant taste and odor. Some embodiments disclosed herein improve the taste and smell of plant-based protein compositions, making them more palatable. In some embodiments, the methods disclosed herein apply to proteins from plant-based source including but not limited to barley, wheat, rice, flaxseed, coconut, buckwheat, pumpkin, hemp, pea, chia, lentil, fava, potato, corn, sunflower, soy, quinoa, amaranth, oat, sorghum, lupin, millet, teff, combinations thereof, or the like. In some specific embodiments, the protein is pea protein. In some embodiments, the protein is not protein derived from Brewers' Spent Grain (BSG). In some embodiments, the methods described herein may be used to prepare a certified organic protein composition.

The plant-based protein used for process disclosed herein may be prepared by taking a plant-based material (e.g., peas) and milling the material to make a flour. Water is then added to make a slurry and passed thru a hydro-cyclone to remove the starch. Alternatively, starch can be removed by adding enzymes and or centrifugation. The resulting slurry (with starch removed) is then adjusted to pH of about 10.0 to solubilize the proteins. The resulting liquid is passed thru a screen to remove the insoluble fibers, adjusted to pH of about 3.5 to precipitate the protein. In some embodiments, the precipitated protein may recovered and further purified according the methods described herein. In some embodiments, the precipitated protein may then be pH adjusted, pasteurized and/or spray dried and then subsequently purified using the methods disclosed herein.

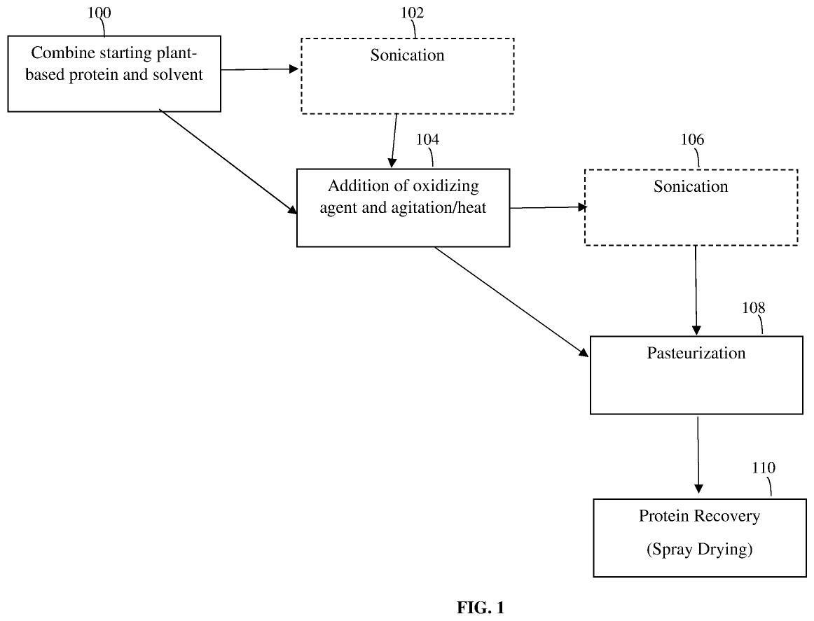

In some embodiments, the process disclosed herein may be a batch process. In other embodiments, the process may be a continuous or semi-continuous process. In some embodiments, the purification disclosed herein may be summarized according to FIG. 1. A vessel equipped with an agitator is used to combine solvent (e.g., water) and bulk plant-based protein (e.g., pea protein) (step 100). After complete dispersion in the solvent, the contents of tank are optionally heated to a desired temperature or maintained at room temperature. The protein/solvent dispersion is treated with an oxidizing agent (e.g., H₂O₂ as a 30% (w/w) solution in water). The oxidizing agent/dispersion mixture is then agitated for a desired time (e.g., 15 minutes) at a desired temperature (e.g., 140-160° F.) (step 104). After treatment with oxidizing agent, the contents of the vessel are pasteurized (step 108) and then recovered (e.g., via spray drying) (step 110). An optional sonication step may be included before (step 102) and/or after (step 106) treatment with the oxidizing agent.

In some embodiments described herein, the method includes adding protein and a solvent to a first vessel to form a first mixture. In some embodiments, the first vessel may be equipped with an agitator. In some embodiments, the protein is a plant-based protein. In some such embodiments, the protein is a pea protein. In some embodiments, the amount of protein to be used may be about 50 lbs, 60 lbs, 70 lbs, 80 lbs, 90 lbs, 100 lbs, 110 lbs, 120 lbs, 130 lbs, 140 lbs, 150 lbs, 160 lbs, 170 lbs, 180 lbs, 190 lbs, 200 lbs, 210 lbs, 220 lbs, 230 lbs, 240 lbs, 240 lbs, 250 lbs, 260 lbs, 270 lbs, 280 lbs, 290 lbs, 300 lbs, or more, or within a range defined by any two of the aforementioned values. For example, in some embodiments, the amount of protein added to the agitation tank may be from about 100 lbs to about 300 lbs, from about 50 lbs to about 200 lbs, from about 100 lbs to about 200 lbs, or from about 120 lbs to about 180 lbs. In some embodiments, the amount of solvent (e.g., water) added to the first vessel to form the first mixture may be about 500 lbs, 550 lbs, 600 lbs, 650 lbs, 700 lbs, 750 lbs, 800 lbs, 850 lbs, 900 lbs, 950 lbs, 1000 lbs, 1100 lbs, 1200 lbs, 1300 lbs, 1400 lbs, 1500 lbs, or more, or more, or within a range defined by any two of the aforementioned values. For example, in some embodiments, the amount of protein added to the agitation tank may be from about 500 lbs to about 1500 lbs, from about 500 lbs to about 1000 lbs, from about 600 lbs to about 800 lbs, or from about 700 lbs to about 1200 lbs.

In some embodiments, the concentration (% w/w) of the protein in the first mixture is about 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, or more, or within a range defined by any two of the aforementioned values. For example, in some embodiments, the concentration (% w/w) of the protein in the first mixture is from about 8% to about 20%, from about 10% to about 20%, from about 12% to about 18%, from about 13% to about 18%, from about 12% to about 15%, from about 15% to about 20%, or from about 13% to about 16%. In some specific embodiments, the concentration (% w/w) of the protein in the first mixture is about 15%.

A suitable ratio of solvent to protein is necessary for optimal agitation and purification. In some embodiments, the mass ratio of solvent to protein is 1:1, 2:1, 3:1, 4:1, 5:1, 6:1, 7:1, 8:1, 9:1, 10:1 or greater than 10:1, or within a range defined by any two of the aforementioned ratios. For example, in some embodiments, the mass ratio of solvent to protein is from about 1:1 to about 10:1, from about 2:1 to about 10:1, from about 3:1 to about 7:1, from about 5:1 to about 10:1 or from about 2:1 to about 6:1. In some specific embodiments, the mass ratio of solvent to protein is about 5:1. Alternatively the ratio of mass of protein to volume of solvent used can be important for optimizing the process disclosed herein. In some embodiments, the ratio of mass of protein to solvent volume (lbs/gal) is 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2.0:1, 2.5:1, 3:1 or greater than 3:1, or within a range defined by any two of the aforementioned ratios. For example, in some embodiments, the ratio of mass of protein to solvent volume is from about 05:1 to about 3:1, from about 1:1 to about 2:1, from about 1.2:1 to about 1.9:1, from about 1:3 to about 1.8:1 or from about 1.6:1 to about 1.8:1. In some specific embodiments, the mass ratio of solvent to protein is about 1.7:1.

The protein is combined with the solvent in the first vessel and agitated until fully dispersed to form a first mixture. In some embodiments, solvent comprises water. In other embodiments, the solvent comprises ethanol. In some specific embodiments, the solvent is water. Once fully dispersed, the first mixture is optionally heated to a desired temperature prior to addition of an oxidizing agent. In some embodiments, the first mixture may be heated to a temperature of about 70° F., 75° F., 80° F., 85° F., 90° F., 95° F., 100° F., 105° F., 110° F., 115° F., 120° F., 125° F., 130° F., 135° F., 140° F., 145° F., 150° F., 155° F., 160° F., 165° F., 170° F., 175° F., 180° F., 185° F., 190° F., 195° F., 200° F., or more, or within a range defined by any two of the aforementioned values. For example, in some embodiments, the first mixture may be heated to a temperature of from about 100° F. to about 200° F., from about 120° F. to about 180° F., about 140° F. to about 195° F., or from about 140° F. to about 170° F. In other embodiments, the first mixture is not heated prior to the addition of the oxidizing agent and is kept at room temperature.

In some embodiments, an oxidizing agent is added to the first mixture of solvent and protein. In some embodiments, the oxidizing agent may be an alkali metal percarbonate, e.g., sodium percarbonate or potassium percarbonate. In some embodiments, the oxidizing agent may be sodium hypochlorite. In other embodiments, the oxidizing agent may be a peroxide. In some embodiments, the oxidizing agent may be hydrogen peroxide. The hydrogen peroxide may be in the form of a food grade solution of H₂O₂ in water. In some embodiments, the hydrogen peroxide solution may be used as an about 5%, 10%, 15%, 20%, 25%, 26%, 27%, 28%, 29%, 30%, 31%, 32%, 33%, 34%, 35%, 36%, 37%, 38%, 39%, 40%, 45%, 50% (w/w) solution in water, or within a range defined by any two of the aforementioned values. For example, in some embodiments, the hydrogen peroxide solution may be used as an about 5%-50% (w/w) solution in water, about 10%-40% (w/w) solution in water, about 20%-40% (w/w), about 30%-40% (w/w) solution in water, or about 30%-35% (w/w) solution in water In some embodiments, the hydrogen peroxide solution may be used as a 34% (w/w) solution in water. In some embodiments, In some embodiments, the mass ratio of protein to oxidizing agent (e.g., H₂O₂) is about 50:1, 60:1, 70:1, 80:1, 90:1, 100:1, 110:1, 120:1, 130:1, 140:1, 150:1, 160:1, 170:1, 180:1, 190:1, 200:1, 210:1, 220:1, 230:1, 240:1, 250:1, 260:1, 270:1, 280:1, 290:1, 300:1, or more, or within a range defined by any two of the aforementioned ratios. For example, in some embodiments, the mass ratio of protein to oxidizing agent is from about 50:1 to about 300:1, from about 100:1 to about 200:1, from about 150:1 to about 200:1, or from about 160:1 to about 170:1. In some specific embodiments, the ratio of protein to oxidizing agent is about 166:1. In some embodiments, the oxidizing agent used is a 30% (w/w) H₂O₂ solution in water. In some embodiments, about 0.3 lbs, 0.4 lbs, 0.5 lbs, 0.6 lbs, 0.7 lbs, 0 8 lbs, 0.9 lbs, 1.0 lbs, 1.1 lbs, 1.2 lbs, 1.3 lbs, 1.4 lbs, 1.5 lbs or more, or a range defined by any two of the aforementioned values, H₂O₂ solution is added to the first mixture. In some embodiments, about 0.5 lbs to 1.5 lbs, about 0.6 lbs to 1.2 lbs, about 0.8 lbs to 1.0 lbs of H₂O₂ is added to the first mixture to form a second mixture. In some embodiments, the oxidizing agent is added over a period of about 1, 2, 3, 4, 5, 6, 7, 8, 9, 10, 15, 20, 25, 30, 35, 40, 45, 50, 55, or 60 minutes or more, or within a range defined by any two of the aforementioned values. In some embodiments, the aforementioned quantities of oxidizing agent refer to the mass of the oxidizing agent rather than to the quantities of solution of oxidizing agent. In some embodiments, the first mixture is continually agitated during addition of the oxidizing agent. Without being bound by a particular theory, the concentration of the oxidizing agent should be sufficiently high to oxidize the aromatic compounds found in the unpurified protein while low enough such that the oxidizing agent does not react with the naturally occurring oils in the protein. In some embodiments, the concentration (% w/w) of the oxidizing agent in the second mixture is about 0.05%, 0.06%, 0.07%, 0.08%, 0.09%, 0.1%, 0.15%, 0.2%, 0.25%, 0.3%, 0.35%, 0.4%, 0.45%, 0.5% or more, or within a range defined by any two of the aforementioned values. For example, in some embodiments, the concentration (% w/w) of the oxidizing agent in the second mixture is from about 0.05% to about 0.5%, from about 0.05% to about 4%, from about 0.1% to about 0.4%, from about 0.05% to about 0.15%, from about 0.1% to about 0.2%, from about 0.1% to about 0.15%, from about 0.06% to about 0.2%, from about 0.07% to about 0.2%, from about 0.08% to about 0.2%, from about 0.09% to about 0.2%, from about 0.07% to about 0.15%, from about 0.08% to about 0.15%, from about 0.07% to about 0.12%, from about 0.08% to about 0.12%, or from about 0.08% to about 0.3%. In some specific embodiments, the oxidizing agent is H₂O₂.

In some embodiments, the second mixture is heated to a temperature of about 100° F., 105° F., 110° F., 115° F., 120° F., 125° F., 130° F., 135° F., 140° F., 145° F., 150° F., 155° F., 160° F., 165° F., 170° F., 175° F., 180° F., 185° F., 190° F., 195° F., 200° F., or more, or within a range defined by any two of the aforementioned values. For example, in some embodiments, the second mixture may be heated to a temperature of from about 100° F. to about 200° F., from about 120° F. to about 180° F., or from about 140° F. to about 170° F. The second mixture may be heated for a period of about 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120 minutes, or within a range defined by any two of the aforementioned times. For example, the second mixture may be heated at the desired temperature for from about 1 minute to 60 minutes, from about 2 minutes to about 30 minutes, or from about 5 minutes to about 20 minutes. It may be desirable to minimize the amount of time the protein/water mixture is treated with peroxide. In some specific embodiments, the second mixture is agitated for no more than about 5, 10, 15, or 20 minutes, or within a range defined by any two of the aforementioned values. In some embodiments, the second mixture is heated at from about 140° F. to about 190° F. for from about 1 minute to 30 minutes. In some such embodiments, the second solution is heated at about 145° F. for about 15 minutes. In other such embodiments, the second solution is heated at about 160° F. for about 15 minutes. In yet other such embodiments, the second solution is heated at about 180° F. for about 15 minutes. In some such embodiments, the second solution is heated at about 145° F. for about 5 minutes. In other such embodiments, the second solution is heated at about 160° F. for about 5 minutes. In yet other such embodiments, the second solution is heated at about 180° F. for about 5 minutes. Ideally, the agitation rate of the second mixture is kept low.

After treatment of the second mixture with the oxidizing agent is complete, the treated mixture may then be optionally subjected to sonication. Sonication of the treated mixture may result in the emulsification of naturally-occurring oils found in the starting bulk protein. Emulsification may result in trapping some of the compounds responsible for undesired taste and smell in the emulsified oil system and may aid in removing such compounds from the purified protein. In some embodiments, the second mixture may be sonicated after treatment with the oxidizing agent. In some embodiments, the second mixture is sonicated for a period of from about 1 minute to about 20 minutes, from about 2 minutes to about 15 minutes, from about 3 minutes to about 10 minutes, or from about 5 minutes to about 10 minutes. The frequency of sonication may be 5 kHz, 10 kHz, 15 kHz, 20 kHz, 25 kHz, 30 kHz, 35 kHz, 40 kHz, 45 kHz, 50 kHz, 55 kHz, 60 kHz, 65 kHz, 70 kHz, 75 kHz, 80 kHz, 85 kHz, 90 kHz, 95 kHz, 100 kHz, or greater, or within a range defined by any two of the aforementioned frequencies.

In some embodiments, the first mixture may be subjected to sonication. In some embodiments, the first mixture is sonicated for a period of from about 1 minute to about 20 minutes, from about 2 minutes to about 15 minutes, from about 3 minutes to about 10 minutes, or from about 5 minutes to about 10 minutes. The frequency of sonication may be 5 kHz, 10 kHz, 15 kHz, 20 kHz, 25 kHz, 30 kHz, 35 kHz, 40 kHz, 45 kHz, 50 kHz, 55 kHz, 60 kHz, 65 kHz, 70 kHz, 75 kHz, 80 kHz, 85 kHz, 90 kHz, 95 kHz, 100 kHz, or greater, or within a range defined by any two of the aforementioned frequencies. In some embodiments, the first mixture may be heated prior to sonication to a temperature of about 160° F., 165° F., 170° F., 175° F., 180° F., 185° F., 190° F., 195° F., 200° F., or more, prior to sonication for a period of 1, 2, 3, 4, 5, 6, 7, 8, 9, or 10 minutes or more. In some embodiments, the first mixture may be allowed to cool to room temperature after heating and prior to sonication.

After sonication, the second mixture may be heat treated for a short period of time in order to stifle any microbial growth. The second mixture may be treated at a temperature of greater than 1, 2, 3, 4, 5, 6, 7, 8, 9, or 10 minutes or more, or within a range defined by any two of the aforementioned values, at a temperature of greater than about 190° F. Upon this pasteurization step, the second mixture may be dried in an appropriate manner (e.g., spray drying) in order to recover purified protein. In some embodiments, the purified protein will have residual hydrogen peroxide content. For example, the amount of residual hydrogen peroxide in a pea protein composition prepared according to the methods disclosed herein is about 0.1 parts per million (ppm), 0.2 ppm, 0.3 ppm, 0.4 ppm, 0.5 ppm, 0.6 ppm, 0.7 ppm, 0.8 ppm, 0.9 ppm, 1 ppm, 2 ppm, 3 ppm, 4 ppm, 5 ppm, 6 ppm, 7 ppm, 8 ppm, 9 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 95 ppm, 100 ppm, or within a range defined by any two of the aforementioned values. For example, the amount of residual hydrogen peroxide in a pea protein composition prepared according to the methods disclosed herein may be from about 0.1 ppm to about 1 ppm, from about 0.1 ppm to about 100 ppm, from about 1 ppm to about 10 ppm, from about 20 ppm to about 50 ppm, or from about 1 ppm to about 50 ppm.

The purified protein prepared according to the methods described herein leads to improvements in protein digestibility and protein quality. Protein digestibility-corrected amino acid score (PDCAAS) is a method of evaluating the quality of a protein based on both the amino acid requirements of humans and their ability to digest it. PDCAAS was adopted by the U.S. Food and Drug Administration and the Food and Agricultural Organization of the United Nations/World Health Organization in 1993 as the preferred method to determine protein quality. PDCAAS is calculated by multiplying the “Protein Digestibility” for a protein composition by the composition's “Amino Acid Score”. The Federal Register, Jan. 6, 1993, Vol. 58, No. 3, P. 2194 provides a standard listing of common protein Digestibility Scores, based on animal studies, and protein concentrate is identified on the Federal Register with a Protein Digestibility of 0.94. In some embodiments, using the methods disclosed herein, a protein with a PDCAAS score of equal to or at least about: 0.85, 0.90, 0.95, 0.97, 0.98, 0.99, 0.999, or within a range defined by any two of the aforementioned values. In some embodiments, the PDCAAS is increased relative to the starting protein to equal to or at least about: 15%, 10%, 5%, 2.5%, or ranges defined by any two of the aforementioned values. This unexpectedly improved property marks improved digestibility.

Protein Digestibility can be analyzed via an in vitro analysis technique, as described in U.S. Pat. No. 9,738,920. The digestibility score derived from this in vitro technique, which involves enzymatically digesting a protein containing sample to simulate digestion that would occur inside a mammalian body, is referred to herein as in vitro Protein Digestibility. The in vitro Protein Digestibility analysis can be performed commercially by Medallion Labs (General Mills; Minneapolis, Minn.). Medallion Labs provides the in vitro Protein Digestibility as a “ASAP-Quality Score” (Animal-Safe Accurate Protein Quality Score).

The in vitro Protein Digestibility uses enzymatic digestion steps similar to stomach and small intestine for protein digestion. For each cleavage of a protein backbone by an enzyme, an alpha-amino nitrogen (primary amine) is exposed which is reactive to the colorimetric reagent, ninhydrin, and allows for quantification of the digestion reaction. The analysis entails a pepsin digestion at a pH of 2, followed by a trypsin/chymotrypsin digestion at a pH of 7.5, followed by a TCA precipitation and centrifugation, followed by the reaction of the resulting supernatant with ninhydrin. Quantification is done by absorbance spectroscopy.

The other component to PDCAAS calculation is Amino Acid Score. The Amino Acid Score compares a protein's eleven Essential Amino Acids: Histidine, Isoleucine, Leucine, Lysine, Methionine+Cysteine (the sulfur-containing amino acids), Phenylalanine+Tyrosine (aromatic amino acids), Threonine, Tryptophan, and Valine, with the recommended essential amino acid protein profiles of The Food and Agricultural Organization of the United Nations/World Health Organization (1985), which vary depending on factors like age, weight, gender, and other criteria. In 2011, FAO published Food and Nutrition Paper #92 “Dietary Protein Quality Evaluation in Human Nutrition” recommended consolidation of the amino acid pattern to three categories: Infant (birth to 6 months), Young Children (6 months to 3 years), and Older Children, Adolescents, and Adults.

The Amino Acid Score compares the above-referenced amino acid pattern which is appropriate for the age of the individual in order to determine any limiting amino acid(s). The lowest concentration of limiting amino acid divided by the pattern for that amino acid equals the Amino Acid Score. For example, for most protein concentrates that are currently available, an upper limit is placed on the Amino Acid Score due to insufficient Sulfur-containing Amino Acids (Methionine+Cysteine). If the complete protein requirement for older children through adults is set at 23 mg/g, and a protein concentrate only has 16 mg/g sulfur-containing amino acids then the formula to calculate the Amino Acid Score would be 16 mg/23 mg=0.71.

Amino acid contents and Amino Acid Scores for the protein concentrates are analyzed using Official Method 988.12 (for amino acids, other than tryptophan) or 988.15 (for tryptophan), as published Official Methods of Analysis of AOAC International, 20th Edition (2016), Gaithersburg, Md. The final formula to determine PDCAAS for a protein concentrate multiplies the Amino Acid Score times the Protein Digestibility. Thus, the PDCAAS for a protein concentrate having an Amino Acid Score of 0.71 and a Protein Digestibility of 0.94 (obtained from the previously identified Federal Register reference) would be calculated as follows: Amino Acid Score 0.71×Protein Digestibility 0.94=0.66 PDCAAS. Commercial plant-based protein concentrates typically are deficient in sulfur-containing amino acids (Cysteine+Methionine) and/or tryptophan with Amino Acid Scores ranging from 0.65 to 0.73 for children aged 6 months to 3 years.

Various embodiments of the protein concentrates are characterized by a complete amino acid profile for older children, adolescents, and adults (ages 3 and up), greater than or equal to 23 milligrams of sulfur-containing amino acids (cysteine+methionine) per gram of protein, an in vitro Protein Digestibility of at least 0.98, and a PDCAAS value of at least 0.98. This includes embodiments of the protein concentrates having an in vitro Protein Digestibility of at least 0.99 and a PDCAAS value of at least 0.99, and further includes embodiments of the protein concentrates having an in vitro Protein Digestibility of 1.0 and a PDCAAS value of 1.0. In some of these embodiments, the protein concentrates are characterized by a complete amino acid profile for children ages 6 months to 3 years, since they contain greater than or equal to 27 milligrams of sulfur-containing amino acids (cysteine+methionine) per gram of protein.

To further illustrate this disclosure, the following examples are included. The examples should not, of course, be construed as specifically limiting the disclosure. Variations of these examples within the scope of the claims are within the purview of one skilled in the art and are considered to fall within the scope of the disclosure as described, and claimed herein. The reader will recognize that the skilled artisan, armed with the present disclosure, and skill in the art is able to prepare and use the disclosure without exhaustive examples. The following examples will further describe the present disclosure, and are used for the purposes of illustration only, and should not be considered as limiting.

### EXAMPLES

### Example 1: Preparation of Purified Hemp Protein

To a vessel equipped with an agitator is added 500 lbs. of reverse osmosis water. Under agitation, 100 lbs of hemp protein is added and the contents of the tank are heated to 90° F. and agitated until fully dispersed. To the tank is added 2.00 lbs of hydrogen peroxide as a 30% (w/w) solution in water. The tank contents of the tank were heated to 160° F. and agitated for 2 hours. The tank contents are then pasteurized at a temperature of >190 OF and subsequently spray dried to provide a purified hemp protein.

The isolated purified hemp protein is evaluated at concentrations of 5 g, 10 g, and 15 g of protein in 250 mL H₂O by a panel of five testers. The samples are evaluated for color, aroma, texture, and sweetness along with the unpurified hemp protein and other hemp proteins.

### Example 2: Preparation of Purified Sunflower Protein

To a vessel equipped with an agitator is added 750 lbs. of reverse osmosis water. Under agitation, 150 lbs of sunflower protein is added and agitated until fully dispersed. To the tank is added 2.00 lbs of hydrogen peroxide as a 50% (w/w) solution in water. The tank contents of the tank are heated to 180° F. and agitated for 1 hour. The subsequent mixture is then sonicated for 10 minutes. The tank contents are then pasteurized at a temperature of >190° F. and subsequently spray dried to provide a purified sunflower protein.

The isolated purified sunflower protein is evaluated at concentrations of 5 g, 10 g, and 15 g of protein in 250 mL H₂O by a panel of five testers. The samples are evaluated for color, aroma, texture, and sweetness along with the unpurified sunflower protein and other sunflower proteins.

### Example 3: Preparation of Purified Flaxseed Protein

To a vessel equipped with an agitator is added 1000 lbs. of reverse osmosis water. Under agitation, 200 lbs of flaxseed protein is added and the contents of the tank are heated to 90° F. and agitated until fully dispersed. To the tank is added 1.0 lbs of hydrogen peroxide as a 30% (w/w) solution in water. The tank contents of the tank are heated to 160° F. and agitated for 1.5 hours. The subsequent mixture is then sonicated for 10 minutes. The tank contents are then pasteurized at a temperature of >190° F. and subsequently spray dried to provide a purified flaxseed protein.

The isolated purified flaxseed protein is evaluated at concentrations of 5 g, 10 g, and 15 g of protein in 250 mL H₂O by a panel of five testers. The samples are evaluated for color, aroma, texture, and sweetness along with the unpurified flaxseed protein and other flaxseed proteins.

### Example 4: Preparation of Purified Flaxseed Protein

To a vessel equipped with an agitator is added 1000 lbs. of reverse osmosis water. Under agitation, 200 lbs of flaxseed protein is added and the contents of the tank are heated to 90° F. and agitated until fully dispersed. To the tank is added 1.5 lbs of sodium percarbonate. The tank contents of the tank are heated to 160° F. and agitated for 1.5 hours. The tank contents are then pasteurized at a temperature of >190° F. and subsequently spray dried to provide a purified flaxseed protein.

The isolated purified flaxseed protein is evaluated at concentrations of 5 g, 10 g, and 15 g of protein in 250 mL H₂O by a panel of five testers. The samples are evaluated for color, aroma, texture, and sweetness along with the unpurified flaxseed protein and other flaxseed proteins.

### Example 5: Preparation of Purified Pea Protein

To a vessel equipped with an agitator was added 750 lbs. of reverse osmosis water. Under agitation, 150 lbs of pea protein P80 (PDCAAS score of 0.96) was added and the contents of the tank were agitated until fully dispersed. To the tank was added 0.90 lbs of hydrogen peroxide as a 30% (w/w) solution in water. The tank contents of the tank were heated to 145° F. and agitated for 15 minutes. The tank contents were then pasteurized at a temperature of >190° F. and subsequently spray dried to provide a purified pea protein (PDCAAS score of 0.98).

The isolated purified pea protein was evaluated at concentrations of 5 g, 10 g, and 15 g of protein in 250 mL H₂O by a panel of five testers. The samples were evaluated for color, aroma, texture, and sweetness along with the unpurified P80 protein and other pea proteins. The purified pea protein prepared according to the methods described herein was found to be the preferred protein composition at all concentrations among all five testers. The testers found that the purified pea protein had an acceptable texture, no to mild smell as compared to the starting P80 pea protein and other pea proteins not purified according to the method described above.

### Example 6: Preparation of Purified Lupin Protein

To a vessel equipped with an agitator is added 500 lbs. of reverse osmosis water. Under agitation, 100 lbs of lupin protein is added and the contents of the tank are heated to 90° F. and agitated until fully dispersed. To the tank is added 3.00 lbs sodium hypochlorite as a 8% (w/w) solution in water. The tank contents of the tank are heated to 160° F. and agitated for 1.5 hours, then sonicated for 10 minutes. The tank contents are then pasteurized at a temperature of >190° F. and subsequently spray dried to provide a purified lupin protein.

The isolated purified hemp protein is evaluated at concentrations of 5 g, 10 g, and 15 g of protein in 250 mL H₂O by a panel of five testers. The samples are evaluated for color, aroma, texture, and sweetness along with the unpurified lupin protein and other lupin proteins.

### Example 7: Flavor Evaluation of Pea Protein

A panel of eleven taste evaluators were tasked evaluating samples of pea protein treated with oxidizing agents under various conditions in reference to a control sample of pea protein that was not subjected to treatment with an oxidizing agent.

Test samples were prepared by initially preparing a 15% w/w solution of pea protein concentrate, which was then subsequently treated with H₂O₂ (35% solution in water) such that the concentration of H₂O₂ in the treated sample was 0.1% or 0.5%, heated to 180° F. for five minutes, and then allowed to cool to room temperature. The resulting solution was then diluted with water to a concentration of 8% w/w pea protein. A control sample of a 15% w/w solution of pea protein was also prepared, heated to 180° F. for five minutes, and then diluted to 8% w/w pea protein with water. The control sample was not treated with an oxidizing agent. Further test samples were prepared such that the concentration of H₂O₂ in the treated sample was 0.05%. Samples A-F were prepared from different pea protein sources. Samples A and D were prepared from Yantai pea protein, Samples B and E were prepared from Ingredion pea protein, and Samples C and F were prepared from Shandong Hua pea protein.

The evaluators were asked to rate the difference in taste between the sample treated with oxidizing agent and the control sample on a scale of 0-10, with 0 representing no difference and 10 representing an extreme difference. Test samples that were prepared such that the concentration of H₂O₂ in the treated sample was 0.1% (samples A, B, and C) were evaluated as shown in Table 1 below. The differences shown are positive differences from control (i.e., improved taste relative to control)

TABLE 1
Positive Differences from Control
For 0.1% H₂O₂ in Treated Sample

| | Difference | | Difference | | Difference |
|---|---|---|---|---|---|
| Test | From | Test | From | Test | From |
| Sample | Control | Sample | Control | Sample | Control |
| A | 8 | B | 7 | C | 9 |
| A | 7 | B | 8 | C | 8 |
| A | 9 | B | 7 | C | 9 |
| A | 9 | B | 9 | C | 8 |
| A | 7 | B | 7 | C | 9 |
| A | 6 | B | 8 | C | 9 |
| A | 8 | B | 9 | C | 7 |
| A | 9 | B | 7 | C | 8 |
| A | 8 | B | 8 | C | 9 |
| A | 9 | B | 7 | C | 7 |
| A | 7 | — | — | — | — |

Test samples that were prepared at a 0.5% concentration of H₂O₂ (Samples D, E, and F) produced were rated significantly different from the control and were deemed objectionable by the reviewers. Test samples that were prepared such that the concentration of H₂O₂ in the treated sample was 0.5% were evaluated as shown in Table 2 below. The differences shown are negative differences from control (i.e., objectionable taste relative to control).

TABLE 2
Negative Differences from Control
For 0.5% H₂O₂ in Treated Sample

| | Difference | | Difference | | Difference |
|---|---|---|---|---|---|
| Test | From | Test | From | Test | From |
| Sample | Control | Sample | Control | Sample | Control |
| D | 7 | E | 8 | F | 9 |
| D | 7 | E | 9 | F | 8 |
| D | 8 | E | 8 | F | 9 |
| D | 9 | E | 9 | F | 9 |
| D | 6 | E | 9 | F | 9 |
| D | 7 | E | 7 | F | 9 |
| D | 9 | E | 9 | F | 7 |
| D | 8 | E | 9 | F | 9 |
| D | 9 | E | 9 | F | 9 |
| D | 9 | E | 7 | F | 8 |
| D | 9 | — | — | — | — |

It is noteworthy that the initial pea protein concentrate needs to be concentrated enough so the small amount of H₂O₂ can be used for treatment. If the pea protein concentrate is too dilute, the small amount of H₂O₂ will be insufficient for treatment. Indeed, when the concentration of H₂O₂ in the treated sample was 0.05%, no taste difference is observed. However, when excess H₂O₂ is used, objectionable taste is observed.

### Example 8: Flavor Evaluation of Sonicated Pea Protein

A panel of ten taste evaluators were tasked evaluating samples of pea protein treated by sonication in reference to a control sample of pea protein that was not subjected to sonication.

A control sample was prepared by initially preparing a 15% w/w solution of pea protein concentrate, which was then subsequently treated heated to 180° F. for five minutes, allowed to cool to room temperature, and then diluted to 8% w/w pea protein with water for tasting. Test sample G was prepared by initially preparing a 15% w/w solution of pea protein concentrate, which was then subsequently treated heated to 180° F. for five minutes, allowed to cool to room temperature, sonicated for 5 minutes, and then diluted to 8% w/w pea protein with water for tasting.

The evaluators were asked to rate the difference in taste between the sample treated with oxidizing agent and the control sample on a scale of 0-10, with 0 representing no difference and 10 representing an extreme difference. The differences shown are positive differences from control (i.e., improved taste relative to control) Sonication resulted in moderate improvement of protein taste relative to control.

TABLE 3
Positive Differences from Control
For Sample Treated by Sonication

| Test | Difference |
|---|---|
| Sample | From Control |
| G | 3 |
| G | 3 |
| G | 4 |
| G | 4 |
| G | 3 |
| G | 2 |
| G | 3 |
| G | 3 |
| G | 3 |
| G | 3 |

While some embodiments have been illustrated and described, a person with ordinary skill in the art, after reading the foregoing specification, can effect changes, substitutions of equivalents and other types of alterations to the compounds of the present technology or salts, pharmaceutical compositions, derivatives, prodrugs, metabolites, tautomers or racemic mixtures thereof as set forth herein. Each aspect and embodiment described above can also have included or incorporated therewith such variations or aspects as disclosed in regard to any or all of the other aspects and embodiments.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, reagents, compounds, compositions, labeled compounds or biological systems, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims, along with the full scope of equivalents to which such claims are entitled.

While the disclosure has been particularly shown and described with reference to a preferred embodiment and various alternate embodiments, it will be understood by persons skilled in the relevant art that various changes in form and details can be made therein without departing from the spirit and scope of the disclosure.

1. A method of preparing a pea protein composition, the method comprising the steps of:
(a) adding pea protein and water to a first vessel to form a first mixture, wherein the concentration of pea protein in the first mixture is from about 12% to about 18% (w/w);
(b) adding an oxidizing agent to the first mixture wherein the oxidizing agent is added over a period of from about 5 minutes to about 120 minutes to form a second mixture, wherein the concentration of the oxidizing agent in the second mixture is greater than 0.05% and less than 0.5% (w/w);
(c) heating the second mixture to a temperature of from about 130° F. to about 200° F. for a period of from about 2 minutes to about 20 minutes; and
(d) isolating purified pea protein from the second mixture.

2. (canceled)

3. The method of claim 1, wherein the concentration of protein in the first mixture is about 15% (w/w).

4. The method of claim 1 wherein the first mixture is agitated.

5. The method of claim 1 wherein the first mixture is heated to a temperature of from about 70° F. to about 200° F.

6. The method of claim 1, wherein the first mixture is heated to a temperature of about 160° F.

7. The method of claim 1 wherein the first mixture is heated to a temperature of about 180° F.

8. The method of claim 1, wherein the oxidizing agent is a peroxide or an alkali metal percarbonate.

9. The method of claim 8, wherein the oxidizing agent is sodium percarbonate or potassium percarbonate.

10. The method of claim 8, wherein the oxidizing agent is hydrogen peroxide solution in water.

11. The method of claim 10, wherein the hydrogen peroxide solution is from about 10% (v/v) to about 50% (v/v).

12. The method of claim 10, wherein the hydrogen peroxide solution is about 35% (v/v).

13. The method of claim 10, wherein the concentration of hydrogen peroxide in the second mixture is greater than 0.05% and less than about 0.15% (w/w).

14. The method of claim 10, wherein the concentration of hydrogen peroxide in the second mixture is about 0.1% (w/w).

15. The method of claim 1, wherein the mass ratio of solvent to protein is from about 1:1 to about 10:1.

16. The method of claim 1, wherein the mass ratio of solvent to protein is about 5:1

17. The method of claim 1, wherein the mass ratio of protein to oxidizing agent is from about 50:1 to about 300:1.

18. (canceled)

19. The method of claim 1, wherein the second mixture is agitated for a period of from about 5 minutes to about 120 minutes, or wherein the second mixture is agitated for a period of about 5 minutes.

20. The method of claim 1, wherein the second mixture is heated to a temperature of from about 140° F. to about 190° F.

21. The method of claim 1, wherein the second mixture is heated to a temperature of about 160° F., or wherein the second mixture is heated to a temperature of about 180° F.

22. The method of claim 1, further comprising sonicating the second mixture.

23. The method of claim 22 wherein the second mixture is sonicated for a period of from about 1 minute to about 20 minutes, or wherein the second mixture is sonicated for a period of about 5 minutes.

24. The method of claim 1, wherein the second mixture is further heated to a temperature of from about 190° F. to about 220° F. for a period of 1 minute to 10 minutes.

25. (canceled)

26. (canceled)

27. (canceled)
